(19) United States
(12) Patent Application Publication
(10) Pub. No.: US 2025/0166639 A1
(43) Pub. Date: May 22, 2025

(54) METHOD AND APPARATUS FOR NEURAL SPATIAL SPEECH CODING FOR MULTI-CHANNEL AUDIO

(71) Applicant: Tencent America LLC, Palo Alto, CA (US)

(72) Inventors: Yong Xu, Bellevue, WA (US); Vinay Kothapally, Palo Alto, CA (US); Dong Yu, Palo Alto, CA (US)

(73) Assignee: Tencent America LLC, Palo Alto, CA (US)

(21) Appl. No.: 18/511,589

(22) Filed: Nov. 16, 2023

(51) Int. Cl. G10L 19/008; G06N 3/0455; G06N 3/0464; G06N 3/08; G10L 19/02; G10L 19/032; G10L 19/26; G10L 25/18; G10L 25/30

(52) U.S. Cl. CPC G10L 19/008; G06N 3/0455; G06N 3/0464; G06N 3/08; G10L 19/0208; G10L 19/032; G10L 19/26; G10L 25/18; G10L 25/30

(57) ABSTRACT

A method performed for performing neural spatial audio coding, comprises: receiving an audio signal comprising a plurality of channels; selecting a channel from the plurality of channels as a reference channel; performing a STFT on the reference channel to generate a frequency domain reference channel; inputting the frequency domain reference channel into a first codec; performing the STFT on the plurality of channels minus the channel selected as the reference channel to generate a spatial covariance matrix; inputting the spatial covariance matrix and the frequency domain reference channel into a second codec; reconstructing the audio signal based on an output of the first codec and an output of the second codec to generate a reconstructed audio signal; and training the first and second codecs.

### FIELD

The disclosure generally relates to spatial speech coding, and, in particular, to a method and apparatus for neural spatial speech coding for multi-channel audio.

### BACKGROUND

An audio and speech codec aims at compressing signals into low bitrate codes for efficient storage or network streaming applications. These coding schemes usually take advantage of some signal models and psycho-acoustics. Some speech codecs use linear predictive modeling for signal analysis. Some audio or music codecs apply a classic perceptual coding technique inspired by the perceptual masking effect of human hearing.

In addition, conventional quantization and entropy coding methods may be applied for discretization and efficient coding respectively in these classic codecs. However, the performance of these conventional methods suffers with very low bit rates (e.g., at 6 kps). While traditional codec(s) struggle to achieve high-quality, perceptually accurate reconstruction at extremely low bitrates, neural codecs offer some solutions to these limitations. Some codecs use time-domain CNNs as encoding and decoding blocks with a residual vector quantization (RVQ) to compress the intermediate latent representations. Furthermore, some codecs use a temporal linear predictive coding technique to further remove temporal redundancies. One codec has been proposed which employs a transformer-based network to model code distribution, an approach originally intended for arithmetic coding, in order to achieve improved compression.

Besides single-channel codecs, a spatial audio codec aims to compress multi-channel audio while preserving the spatial information. Such multi-channel codecs are commonly designed for playback systems, or multi-speaker systems (e.g., stereo coding). Typically, a spatial audio codec adheres to a pipeline consisting of the following steps: (i) downmix the multi-channel audio into mono or stereo, and code with a traditional audio codec, (ii) some sub-band spatial parameters are extracted from the multi-channel audio and coded channel-wise and band-wise, (iii) The decoder then resynthesizes the multi-channel audio from the previous two components. Since these codecs are designed for specific playback systems, they do not consider microphone array spatial recording systems.

Some codecs may apply this scheme to microphone array recorded speech, but without any reverberation (e.g., only the direct path exists). These methods do not use any neural networks and also do not fully exploit inter-channel or inter-band correlations. This means that for a decent reconstruction, the system needs to have reasonably large bands coded separately for each channel, resulting in high coding bit rates.

### SUMMARY

According to one or more embodiments, a method performed by at least one processor for performing neural spatial audio coding, comprising: receiving an audio signal comprising a plurality of channels; selecting a channel from the plurality of channels as a reference channel; performing a short time fourier transform (STFT) on the reference channel to generate a frequency domain reference channel; inputting the frequency domain reference channel into a first codec that comprises a first neural network for encoding the frequency domain reference channel and a second neural network for decoding the frequency domain reference channel; performing the STFT on the plurality of channels minus the channel selected as the reference channel to generate a spatial covariance matrix; inputting the spatial covariance matrix and the frequency domain reference channel into a second codec that comprises a third neural network for encoding the spatial covariance matrix and the frequency domain reference channel and a fourth neural network for decoding the spatial covariance matrix; reconstructing the audio signal based on an output of the first codec and an output of the second codec to generate a reconstructed audio signal; training the first codec based on a comparison of the output of the first codec with the frequency domain reference channel; and training the second codec based on a comparison of the reconstructed audio signal with the plurality of channels of the audio signal minus the reference channel.

According to one or more embodiments, a codec for performing neural spatial audio coding, comprising: at least one memory configured to store program code; and at least one processor configured to read the program code and operate as instructed by the program code, the program code including: receiving code configured to cause the at least one processor to receive an audio signal comprising a plurality of channels; selecting code configured to cause the at least one processor to select a channel from the plurality of channels as a reference channel; first performing code configured to cause the at least one processor to perform a short time fourier transform (STFT) on the reference channel to generate a frequency domain reference channel; first inputting code configured to cause the at least one processor to input the frequency domain reference channel into a first codec that comprises a first neural network for encoding the frequency domain reference channel and a second neural network for decoding the frequency domain reference channel; second performing code configured to cause the at least one processor to perform the STFT on the plurality of channels minus the channel selected as the reference channel to generate a spatial covariance matrix; second inputting code configured to cause the at least one processor to input the spatial covariance matrix and the frequency domain reference channel into a second codec that comprises a third neural network for encoding the spatial covariance matrix and the frequency domain reference channel and a fourth neural network for decoding the spatial covariance matrix; reconstructing code configured to cause the at least one processor to reconstruct the audio signal based on an output of the first codec and an output of the second codec to generate a reconstructed audio signal; first training code configured to cause the at least one processor to train the first codec based on a comparison of the output of the first codec with the frequency domain reference channel; and second training code configured to cause the at least one processor to train the second codec based on a comparison of the reconstructed audio signal with the plurality of channels of the audio signal minus the reference channel.

A non-transitory computer readable medium having instructions stored therein, which when executed by a processor in a codec for performing neural spatial audio coding, cause the processor to execute a method comprising: receiving an audio signal comprising a plurality of channels; selecting a channel from the plurality of channels as a reference channel; performing a short time fourier transform (STFT) on the reference channel to generate a frequency domain reference channel; inputting the frequency domain reference channel into a first codec that comprises a first neural network for encoding the frequency domain reference channel and a second neural network for decoding the frequency domain reference channel; performing the STFT on the plurality of channels minus the channel selected as the reference channel to generate a spatial covariance matrix; inputting the spatial covariance matrix and the frequency domain reference channel into a second codec that comprises a third neural network for encoding the spatial covariance matrix and the frequency domain reference channel and a fourth neural network for decoding the spatial covariance matrix; reconstructing the audio signal based on an output of the first codec and an output of the second codec to generate a reconstructed audio signal; training the first codec based on a comparison of the output of the first codec with the frequency domain reference channel; and training the second codec based on a comparison of the reconstructed audio signal with the plurality of channels of the audio signal minus the reference channel.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is a diagram of a two-branch spatial codec, according to embodiments.

FIG. 4 is a table illustrating evaluation results of the two-branch spatial codec.

FIG. 5 is a diagram of a spatial features visualization, according to embodiments.

FIG. 6 is a flowchart of an example process for spatial coding using the two-branch spatial codec, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

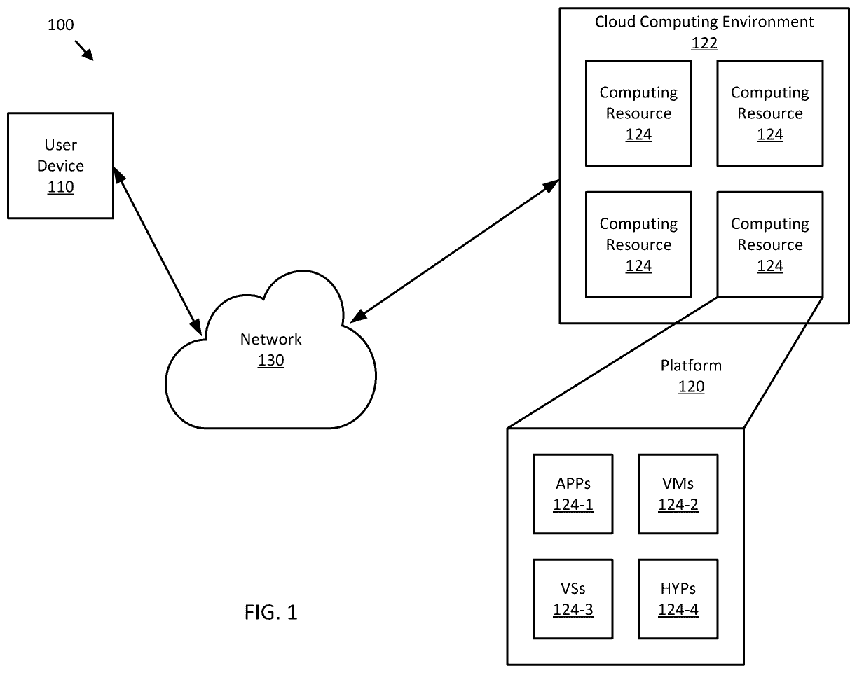

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSS) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

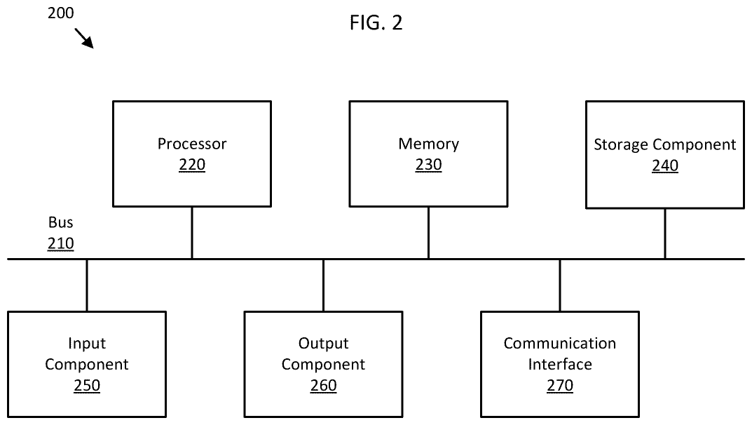

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

Embodiments of the present disclosure are directed to encoding speech captured by a microphone array using deep learning techniques with the aim of preserving and accurately reconstructing crucial spatial cues embedded in multi-channel recordings. In one or more examples, a neural spatial audio coding framework achieves a high compression ratio, leveraging a single-channel neural sub-band codec and a spatial codec. Embodiments of the present disclosure include two phases: (i) a neural sub-band codec is designed to encode the reference channel with low bit rates, and (ii), a spatial codec that captures relative spatial information for accurate multi-channel reconstruction at the decoder end. In one or more examples, a novel evaluation metric is used to assess the spatial cue preservation: (i) spatial similarity, which calculates cosine similarity on a spatially intuitive beamspace, and (ii), beamformed audio quality. The embodiments of the present disclosure show superior spatial performance compared with high bitrate baselines and black-box neural architecture.

The embodiments of the present disclosure aims to address the high coding rate challenge with neural networks. For example, the codecs of the present disclosure includes two branches: the first branch codes the reference channel audio, while the second branch codes the spatial information. On the decoder side, the first branch's decoder outputs the reconstructed reference channel. Subsequently, the decoder's output of the second branch and the reconstructed reference channel are used jointly to synthesize all non-reference channels. The codec of the present disclosure is trained and tested on a synthesized multi-channel spatially rich reverberant dataset with speech from a single speaker. Furthermore, the embodiments of the present disclosure use several novel metrics to evaluate spatial cue preservation. One metric is spatial similarity, which calculates a cosine similarity between estimated and ground-truth spatial features. Spatial features may be designed by beamforming towards a few fixed directions. This metric may be a more intuitive metric since the spatial features are directly related to real-world directions. Another metric may use beamforming performance as a metric to validate the spatial codec's ability to preserve both the spectral quality and the main directivity. The spatial codec of the present disclosure with 12 kbps of bitrate performs significantly better than 96 kbps (e.g., 8 channels×12 kbps/channel) OPUS and other channel-independent neural codecs. A black-box model was designed for comparison.

The embodiments of the present disclosure provide a two-branch codec framework for neural spatial speech coding. The first branch may be a reference channel codec to code source spectral information. The second branch may extract and code the spatial information for multi-channel resynthesis. In one or more examples, several novel metrics may be used to measure spatial and spectral quality, including spatial similarity and beamforming performance. These metrics show that a 12 kbps approach, for example, performs much better than all baselines including 96 kbps. A black-box MIMO E2E model was also designed for comparison. While the system was tested on a single-speaker reverberant speech signals, as understood by one of ordinary skill in the art, this approach is able to generalize to more complicated scenarios like multi-speaker, music sources, and moving sources. The embodiments of the present disclosure may be used in scenarios such as online meeting, VOIP based communication, etc.

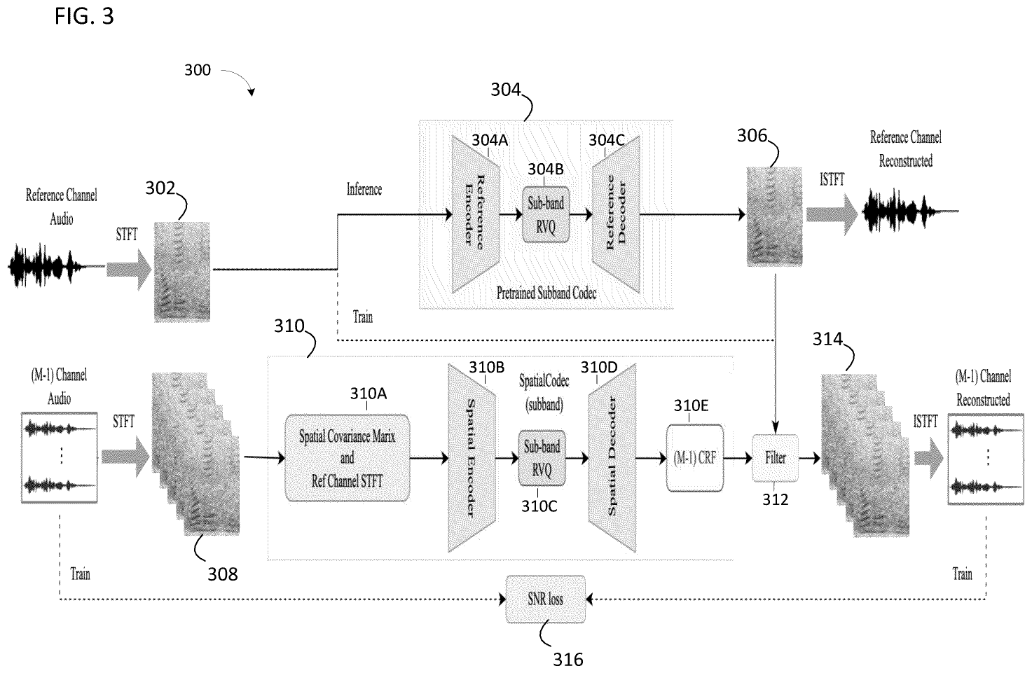

FIG. 3 illustrates an example architecture of a two-branch codec 300, which may include two main branches: (i) a single-channel sub-band codec pre-trained codec to code a reference channel of a microphone array, and (ii) a spatial codec that codes spatial information to reconstruct multi-channel audio signals. The first branch may include the single-channel sub-band codec 304, and the second branch may include the spatial codec 310. The two-branch codec 300 may be implemented by one or more processors such as the processor 220 (FIG. 2). For example, the single-channel sub-band codec 304 and the spatial codec 310 may be implemented by the same processor or different processors. In one or more examples, each of the codecs 304 and 310 may include respective encoders and decoders, where the encoders are included in a first device, and the decoders are included in a second device. The first device and the second device may communicate with each other wirelessly via Wi-Fi, Bluetooth, etc.

According to one or more embodiments, the single-channel sub-band codec 304 may be a neural frequency domain sub-band codec. The frequency domain codec may be used instead of time-domain codecs the structure of the frequency domain codec may align with the spatial codec 310 in the frequency domain, discussed in further detail below. The input to the single-channel sub-band codec 304 may be the short-time Fourier-transform (STFT) of a reference channel. For example, an audio signal may be received from an M-array microphone. Thus, in this example, the audio signal include M-channels. One of the channels may be selected as a reference channel, where the STFT (302) is performed on the reference channel to generate a frequency domain reference channel. The frequency domain reference channel may be input into the single-channel sub-band codec 304. The input x_{ref}∈R^{2×T×F} is the STFT of the reference channel audio, where 2 corresponds to real and imaginary components.

In one or more examples, the codec 304 includes 2D-CNNs with residual blocks treating real-imaginary as the channel dimension for the encoder and decoder. For example, the codec 304 may include an encoder 304A, a quantizer 304B, and a decoder 304B. The encoder 304A and decoder 304B may each be two-dimensional convolutional neural networks 2D-CNNs.

The encoder 304A and the decoder 304B may have six convolutional layers, each followed by a residual unit. For the encoder 304A, the six layers' kernel and stride for the time dimension may be 3 and 1, respectively. The kernels and strides for the frequency dimension may be [5,3,3,3,3,4] and [2,2,2,2,1], respectively. The output channel dimensions for each of the layers may be [16, 32, 64, 128, 128, 256]. In one or more examples, a 640-point FFT may be used, which means the encoder 304A may compress the frequency dimension from 321 to 6 convolutional sub-bands. The 6 sub-bands may be coded independently using residual vector quantization. The decoder 304B may be the opposite transpose convolution version of the encoder 304A.

In one or more examples, each residual unit may contain two residual blocks. Each block may contain three 2-D time-dilated CNN layers with skip connections. The first block's three layers' kernel and dilation sizes may be [(3,3), (3,5), (3,5)] and [(1,1), (3,1), (5,1)], respectively, in order of (time, freq). The second block's corresponding configurations may be [(7,3), (7,5), (7,5)] and [(1,1), (3,1), (5,1)].

According to one or more embodiments, the spatial codec 310 may have the same structure as the codec 304, except input, output, and channel dimensions of the six convolutional layers may be different.

The input of spatial codec 310 may be the reference channel STFT (e.g., frequency domain reference channel) and spatial covariance matrix (310A) concatenated in the channel dimension. Given an M-channel STFT X (t, f)∈C^{M×1}, the spatial covariance matrix φ(t, f)∈C^{M×M} may be defined to be:

$$φ ( t , f ) = X ( t , f ) {X ( t , f )}^{H} \qquad Eq . ( 1 )$$

The spatial covariance matrix may be obtained by performing the STFT 308 on the M−1 channels (e.g., non-reference channels). Then the real and imaginary parts of φ(t, f) may be concatenated with the real and imaginary part of the reference channel STFT, which gives a 2(M²+1) dimensional real feature for each time-frequency bin. The feature may then be treated as the channel dimension when fed into the spatial codec 310.

The spatial codec 310 may include encoder 310B, quantizer 310C, and decoder 310D. The encoder 310B and decoder 310D may each be 2D-CNNs. The output channel dimensions for all the layers in the encoder may be [128, 128, 128, 128, 256, 256]. Otherwise, the encoder 310B and quantizer 310C are the same as the reference channel codec 304. For the spatial decoder 310, the output may be M−1 complex ratio filters (CRFs) 310E Wₘ(t, f)∈C^{2L+1,2K+1}, m∈[1, . . . , M−1] for all the non-reference channels. The CRFs 310E may encode the spatial relative transfer functions. For example, assume the output of the reference channel STFT is \hat{X}_{ref}∈C^{T×F}, then all non-reference channels for m∈[1, . . . , M−1] may be:

$${\hat{X}}_{m}^{non\_ref} ( t , f ) = {{\sum }_{l = - L}}^{L} {{\sum }_{k = - K}}^{K} {W}_{m} ( t , f , l , k ) {\hat{X}}_{ref} ( t + l , f + k ) \qquad Eq . ( 2 )$$

Thus, the last layer of the spatial decoder's output channel dimension may be 2×(2L+1)×(2K+1)×(M−1), where the first 2 corresponds to real and imaginary.

The output of the spatial codec 310 may be provided to filter 310. Furthermore more, the filter 312 may receive the inverse STFT (306) of the output of the codec 304. The inverse STFT (314) may be performed on the output of the filter 312 to obtain the M−1 reconstructed channels (e.g., reconstructed non-reference channels).

According to one or more embodiments, the training loss of the first branch may be based reconstruction loss, adversarial loss, and codebook learning loss. In one or more examples, the training loss of the first branch may be a time-domain SNR loss with weighting lambda equal to 5. The SNR loss may be defined as:

$${L}_{SNR} ( x , \hat{x} 〉 {=}^{△} - 10 {log}_{10} ( \frac{{‖ x ‖}^{2}}{{‖ x - \hat{x} ‖}^{2}} ) \qquad Eq . ( 3 )$$

In the above equation, x may refer to the reference channel, and x may refer to the reconstructed reference channel.

According to one or more embodiments, the second branch may be trained separately with respect to the first branch. During training, the complex ratio filter (CRF) may be applied to the original reference channel audio instead of the reconstructed reference channel from the first branch. The reason is that even after pre-training, the first branch may only output reconstructed speech that is perceptually equivalent to the original speech. The underlying spectrogram or waveform may not have an exact match. Therefore, if the CRF is applied to the reconstructed speech, the original non-reference channel audio may not be used as learning targets due to the mismatching problem of the first branch. Thus, during training, in contrast to Eq. (2):

$${\hat{X}}_{m}^{non\_ref} ( t , f ) = {{\sum }_{l = - L}}^{L} {{\sum }_{k = - K}}^{K} {W}_{m} ( t , f , l , k ) {X}_{ref} ( t + l , f + k ) , \qquad Eq . ( 4 )$$

where \hat{X}_{ref} is substituted as the original reference channel signal X_{ref}. Then, the time domain SNR loss averaged over all non-reference channels may be used as follows:

$${L}_{all} = \frac{1}{M - 1} {\sum }_{m = 1}^{M - 1} {L}_{SNR} ( ISTFT ( {X}_{m}^{non\_ref} ) , ISTFT ( {\hat{X}}_{m}^{non\_ref} ) ) \qquad Eq . ( 5 )$$

$$\text{?}$$

$$\text{?} \text{indicates text missing or illegible when filed}$$

According to one or more embodiments, in inference, the variable \hat{X}_{ref}^{non_ref} may be obtained using Eq. (2). The first branch's sub-band codec may reconstruct the reference channel audio. Then, the second branch's spatial codec may reconstruct M−1 complex ratio filters, which are applied to the reconstructed reference channel audio to get M−1 reconstructed non-reference channels.

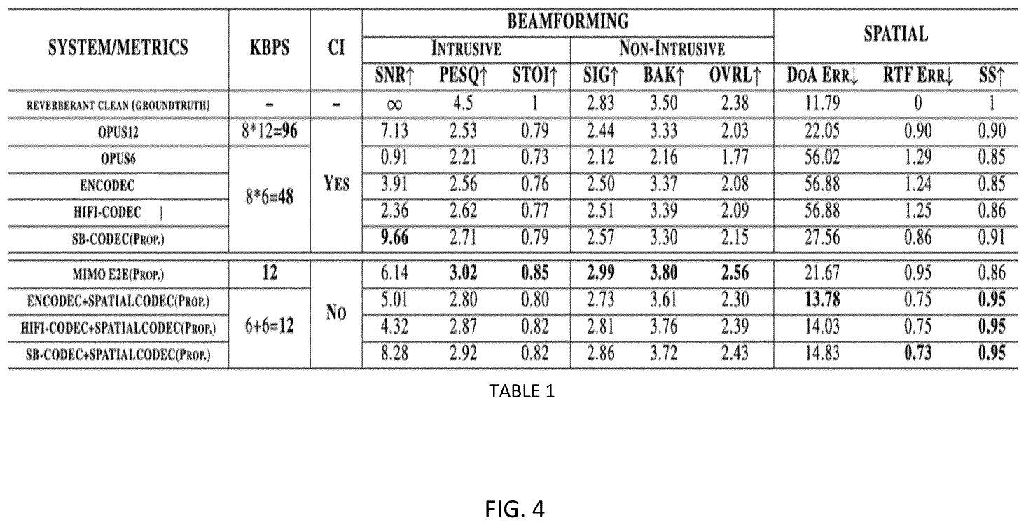

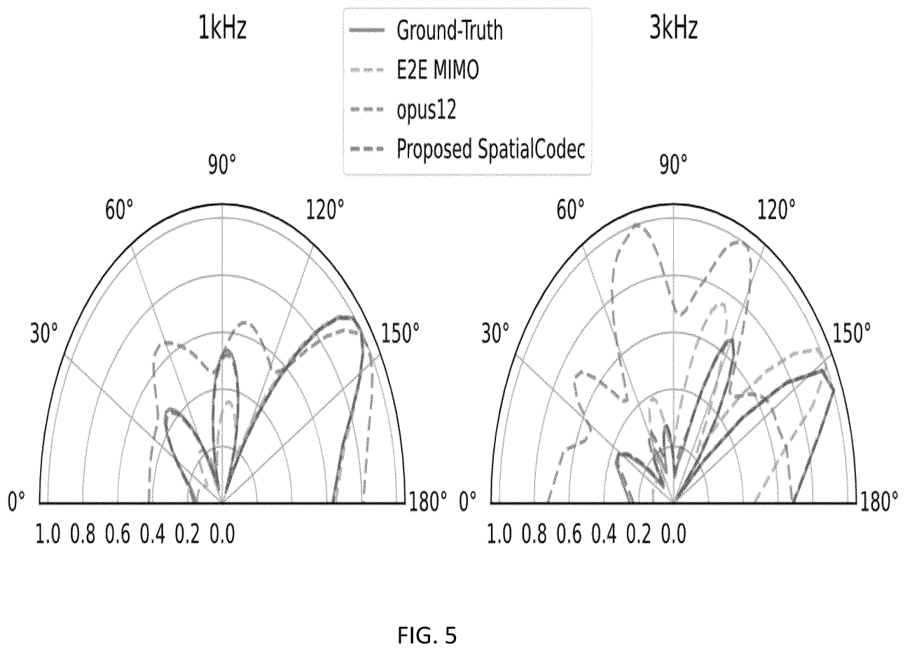

The embodiments of the present disclosure, including the two-branch neural network based spatial codec, achieves significantly better spatial reconstruction performance compared to conventional methods (e.g., OPUS, channel independent codec, channel independent Hifi-codec). The codec according to the embodiments of the present disclosure only needs 12 kbps bandwidth to code all 8 channel audio. Table 1 (FIG. 4) shows the evaluation results of all proposed and baseline models. The inventors observed that the codec of the present disclosure achieves much better performance in all metrics than any other higher bitrate baselines, while maintaining only 12 kbps of bitrate in total. Furthermore, as illustrated in Table, it is observed that that channel-independent coding baselines are not able to preserve spatial information well even though each channel is coded with decent coding rates. Furthermore, as illustrated in Table 1, the black-box MIMO E2E model is worse than two-branch approach in spatial performance (e.g., spatial similarity (SS) 0.86 vs. 0.95), which shows the difficulty to directly learn spatial preservation through such a black-box network. FIG. 5 illustrates spatial features visualization for 1 kHz and 3 kHz.

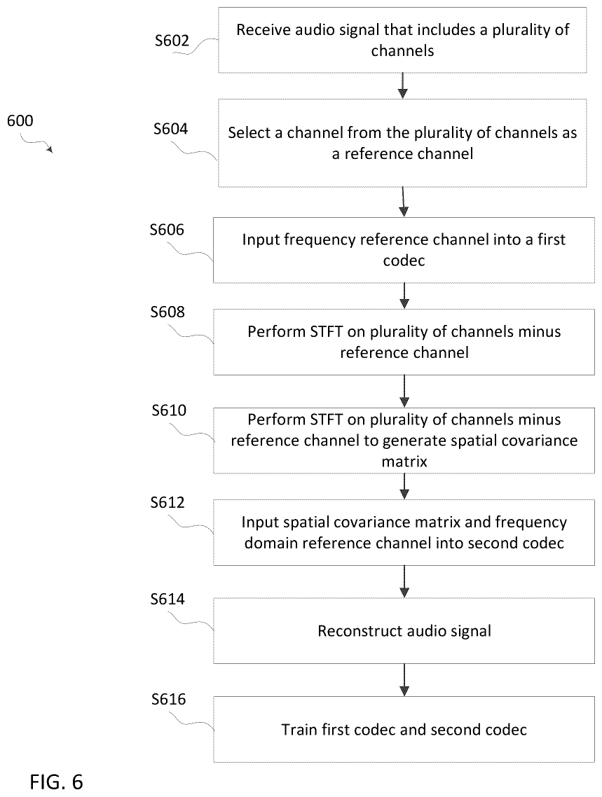

FIG. 6 is a flowchart of an example process for spatial coding using the two-branch spatial codec, according to embodiments. For example, the process illustrated in FIG. 6 is performed using the two-branch spatial codec 300 illustrated in FIG. 3.

The process may start at operation S602 where an audio signal comprising a plurality of channels. For example, the audio signal may be received from a M-array microphone where each array corresponds to a channel in a reference channel.

The process proceeds to operation S604 where a channel from the plurality of channels is selected as a reference channel.

The process proceeds to operation S606 where the STFT is performed on the reference channel to generate a frequency domain reference channel.

The process proceeds to operation S608, where the frequency domain reference channel is input into a first codec that comprises a first neural network for encoding the frequency reference channel and a second neural network for decoding the frequency reference channel. For example, the frequency domain reference channel is input into the single-channel sub-band codec 304.

The process proceeds to operation S610 where the STFT is performed on the plurality of channels minus the channel selected as the reference channel to generate a spatial covariance matrix.

The process proceeds to operation S612 where the spatial covariance matrix and frequency domain reference channel are input into a second codec. For example, the spatial covariance matrix and the frequency domain reference channel are input into the spatial codec 310.

The process proceeds to operation S614 where the audio signal is reconstructed based on an output of the first codec and an output of the second codec to generate a reconstructed audio signal. For example, as discussed with respect to FIG. 3, the M−1 non-reference channels are reconstructed based on the output of the codec 304 and the codec 310.

The process proceeds to operation S616, where the first and second codecs are trained. For example, the first codec may be trained based on a comparison of the output of the first codec with the frequency reference channel and the second codec may be trained based on a comparison of the reconstructed audio signal with the plurality of channels of the audio signal minus the reference channel.

The proposed methods disclosed herein may be implemented by processing circuitry (e.g., one or more processors or one or more integrated circuits). In one example, the one or more processors execute a program that is stored in a non-transitory computer-readable medium to perform one or more of the proposed methods.

The techniques described above may be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The above disclosure also encompasses the embodiments listed below:
(1) A method performed by at least one processor for performing neural spatial audio coding, comprising: receiving an audio signal comprising a plurality of channels; selecting a channel from the plurality of channels as a reference channel; performing a short time fourier transform (STFT) on the reference channel to generate a frequency domain reference channel; inputting the frequency domain reference channel into a first codec that comprises a first neural network for encoding the frequency domain reference channel and a second neural network for decoding the frequency domain reference channel; performing the STFT on the plurality of channels minus the channel selected as the reference channel to generate a spatial covariance matrix; inputting the spatial covariance matrix and the frequency domain reference channel into a second codec that comprises a third neural network for encoding the spatial covariance matrix and the frequency domain reference channel and a fourth neural network for decoding the spatial covariance matrix; reconstructing the audio signal based on an output of the first codec and an output of the second codec to generate a reconstructed audio signal; training the first codec based on a comparison of the output of the first codec with the frequency domain reference channel; and training the second codec based on a comparison of the reconstructed audio signal with the plurality of channels of the audio signal minus the reference channel.
(2) The method according to feature (1), in which the first neural network of the first codec is a two-dimensional convolutional neural network (2D-CNN), and the second neural network of the first codec is a transpose of the 2D-CNN.
(3) The method according to feature (1) or (2), in which the third neural network of the second codec is a two-dimensional convolutional neural network (2D-CNN), and the fourth neural network of the first codec is a transpose of the 2D-CNN.
(4) The method according to any one of features (1)-(3), in which the second codec further comprises a plurality complex ratio filters, in which a total number of the complex ratio filters corresponds to the plurality of audio channels minus the reference channel.
(5) The method according to any one of features (1)-(4), in which the reconstructing the audio signal comprises (i) performing an inverse STFT on an output of the first codec to generate a reconstructed reference channel, (ii) inputting the reconstructed reference channel and the output of the second codec into a filter, and (iii) performing an inverse STFT on an output of the filter to obtain the reconstructed audio signal.
(6) The method according to any one of features (1)-(5), in which the training of the first codec is based on an signal-to-noise ratio (SNR) loss function applied to the frequency domain reference channel and the output of the first codec.
(7) The method according to any one of features (1)-(6), in which the training of the second codec is based on an signal-to-noise ratio (SNR) loss applied to each non-reference channel and corresponding reconstructed non-reference channel.
(8) The method according to any one of features (1)-(7), in which the first codec further comprises a first quantizer that quantizes an output of the first neural network and provides the quantized output of the first neural network to the second neural network, and in which the second code further comprises a second quantizer that quantizes an output of the third neural network and provides the quantized output of the third neural network to the second neural network.
(9) The method according to any one of features (1)-(8), in which the audio signal is captured by a microphone comprising a plurality of arrays corresponding to the plurality of channels of the audio signal.
(10) A codec for performing neural spatial audio coding, comprising: at least one memory configured to store program code; and at least one processor configured to read the program code and operate as instructed by the program code, the program code including: receiving code configured to cause the at least one processor to receive an audio signal comprising a plurality of channels; selecting code configured to cause the at least one processor to select a channel from the plurality of channels as a reference channel; first performing code configured to cause the at least one processor to perform a short time fourier transform (STFT) on the reference channel to generate a frequency domain reference channel; first inputting code configured to cause the at least one processor to input the frequency domain reference channel into a first codec that comprises a first neural network for encoding the frequency domain reference channel and a second neural network for decoding the frequency domain reference channel; second performing code configured to cause the at least one processor to perform the STFT on the plurality of channels minus the channel selected as the reference channel to generate a spatial covariance matrix; second inputting code configured to cause the at least one processor to input the spatial covariance matrix and the frequency domain reference channel into a second codec that comprises a third neural network for encoding the spatial covariance matrix and the frequency domain reference channel and a fourth neural network for decoding the spatial covariance matrix; reconstructing code configured to cause the at least one processor to reconstruct the audio signal based on an output of the first codec and an output of the second codec to generate a reconstructed audio signal; first training code configured to cause the at least one processor to train the first codec based on a comparison of the output of the first codec with the frequency domain reference channel; and second training code configured to cause the at least one processor to train the second codec based on a comparison of the reconstructed audio signal with the plurality of channels of the audio signal minus the reference channel.
(11) The codec according to feature (10), in which the first neural network of the first codec is a two-dimensional convolutional neural network (2D-CNN), and the second neural network of the first codec is a transpose of the 2D-CNN.
(12) The codec according to feature (10) or (11), in which the third neural network of the second codec is a two-dimensional convolutional neural network (2D-CNN), and the fourth neural network of the first codec is a transpose of the 2D-CNN.
(13) The codec according to any one of features (10)-(12), in which the second codec further comprises a plurality complex ratio filters, in which a total number of the complex ratio filters corresponds to the plurality of audio channels minus the reference channel.
(14) The codec according to any one of features (10)-(13), in which the reconstructing code further comprises (i) third performing code configured to cause the at least one processor to perform an inverse STFT on an output of the first codec to generate a reconstructed reference channel, (ii) third inputting code configured to cause the at least one processor to input the reconstructed reference channel and the output of the second codec into a filter, and (iii) fourth performing code configured to cause the at least one processor to perform an inverse STFT on an output of the filter to obtain the reconstructed audio signal.
(15) The codec according to any one of features (10)-(14), in which the first training code is based on an signal-to-noise ratio (SNR) loss function applied to the frequency domain reference channel and the output of the first codec.
(16) The codec according to any one of features (10)-(15), in which the second training code is based on an signal-to-noise ratio (SNR) loss applied to each non-reference channel and corresponding reconstructed non-reference channel.
(17) The codec according to any one of features (10)-(16), in which the first codec further comprises a first quantizer that quantizes an output of the first neural network and provides the quantized output of the first neural network to the second neural network, and in which the second code further comprises a second quantizer that quantizes an output of the third neural network and provides the quantized output of the third neural network to the second neural network.
(18) The codec according to any one of features (10)-(17), in which the audio signal is captured by a microphone comprising a plurality of arrays corresponding to the plurality of channels of the audio signal.
(19) A non-transitory computer readable medium having instructions stored therein, which when executed by a processor in a codec for performing neural spatial audio coding, cause the processor to execute a method comprising: receiving an audio signal comprising a plurality of channels; selecting a channel from the plurality of channels as a reference channel; performing a short time fourier transform (STFT) on the reference channel to generate a frequency domain reference channel; inputting the frequency domain reference channel into a first codec that comprises a first neural network for encoding the frequency domain reference channel and a second neural network for decoding the frequency domain reference channel; performing the STFT on the plurality of channels minus the channel selected as the reference channel to generate a spatial covariance matrix; inputting the spatial covariance matrix and the frequency domain reference channel into a second codec that comprises a third neural network for encoding the spatial covariance matrix and the frequency domain reference channel and a fourth neural network for decoding the spatial covariance matrix; reconstructing the audio signal based on an output of the first codec and an output of the second codec to generate a reconstructed audio signal; training the first codec based on a comparison of the output of the first codec with the frequency domain reference channel; and training the second codec based on a comparison of the reconstructed audio signal with the plurality of channels of the audio signal minus the reference channel.
(20) The non-transitory computer readable medium according to feature (19), in which the first neural network of the first codec is a two-dimensional convolutional neural network (2D-CNN), and the second neural network of the first codec is a transpose of the 2D-CNN.

What is claimed is:

1. A method performed by at least one processor for performing neural spatial audio coding, comprising:
receiving an audio signal comprising a plurality of channels;
selecting a channel from the plurality of channels as a reference channel;
performing a short time fourier transform (STFT) on the reference channel to generate a frequency domain reference channel;
inputting the frequency domain reference channel into a first codec that comprises a first neural network for encoding the frequency domain reference channel and a second neural network for decoding the frequency domain reference channel;
performing the STFT on the plurality of channels minus the channel selected as the reference channel to generate a spatial covariance matrix;
inputting the spatial covariance matrix and the frequency domain reference channel into a second codec that comprises a third neural network for encoding the spatial covariance matrix and the frequency domain reference channel and a fourth neural network for decoding the spatial covariance matrix;
reconstructing the audio signal based on an output of the first codec and an output of the second codec to generate a reconstructed audio signal;
training the first codec based on a comparison of the output of the first codec with the frequency domain reference channel; and
training the second codec based on a comparison of the reconstructed audio signal with the plurality of channels of the audio signal minus the reference channel.

2. The method according to claim 1, wherein the first neural network of the first codec is a two-dimensional convolutional neural network (2D-CNN), and the second neural network of the first codec is a transpose of the 2D-CNN.

3. The method according to claim 1, wherein the third neural network of the second codec is a two-dimensional convolutional neural network (2D-CNN), and the fourth neural network of the first codec is a transpose of the 2D-CNN.

4. The method according to claim 1, wherein the second codec further comprises a plurality complex ratio filters, wherein a total number of the complex ratio filters corresponds to the plurality of audio channels minus the reference channel.

5. The method according to claim 1, wherein the reconstructing the audio signal comprises (i) performing an inverse STFT on an output of the first codec to generate a reconstructed reference channel, (ii) inputting the reconstructed reference channel and the output of the second codec into a filter, and (iii) performing an inverse STFT on an output of the filter to obtain the reconstructed audio signal.

6. The method according to claim 1, wherein the training of the first codec is based on an signal-to-noise ratio (SNR) loss function applied to the frequency domain reference channel and the output of the first codec.

7. The method according to claim 1, wherein the training of the second codec is based on an signal-to-noise ratio (SNR) loss applied to each non-reference channel and corresponding reconstructed non-reference channel.

8. The method according to claim 1, wherein the first codec further comprises a first quantizer that quantizes an output of the first neural network and provides the quantized output of the first neural network to the second neural network, and wherein the second code further comprises a second quantizer that quantizes an output of the third neural network and provides the quantized output of the third neural network to the second neural network.

9. The method according claim 1, wherein the audio signal is captured by a microphone comprising a plurality of arrays corresponding to the plurality of channels of the audio signal.

10. A codec for performing neural spatial audio coding, comprising:
at least one memory configured to store program code; and
at least one processor configured to read the program code and operate as instructed by the program code, the program code including:
receiving code configured to cause the at least one processor to receive an audio signal comprising a plurality of channels;
selecting code configured to cause the at least one processor to select a channel from the plurality of channels as a reference channel;
first performing code configured to cause the at least one processor to perform a short time fourier transform (STFT) on the reference channel to generate a frequency domain reference channel;
first inputting code configured to cause the at least one processor to input the frequency domain reference channel into a first codec that comprises a first neural network for encoding the frequency domain reference channel and a second neural network for decoding the frequency domain reference channel;
second performing code configured to cause the at least one processor to perform the STFT on the plurality of channels minus the channel selected as the reference channel to generate a spatial covariance matrix;
second inputting code configured to cause the at least one processor to input the spatial covariance matrix and the frequency domain reference channel into a second codec that comprises a third neural network for encoding the spatial covariance matrix and the frequency domain reference channel and a fourth neural network for decoding the spatial covariance matrix;
reconstructing code configured to cause the at least one processor to reconstruct the audio signal based on an output of the first codec and an output of the second codec to generate a reconstructed audio signal;
first training code configured to cause the at least one processor to train the first codec based on a comparison of the output of the first codec with the frequency domain reference channel; and
second training code configured to cause the at least one processor to train the second codec based on a comparison of the reconstructed audio signal with the plurality of channels of the audio signal minus the reference channel.

11. The codec according to claim 10, wherein the first neural network of the first codec is a two-dimensional convolutional neural network (2D-CNN), and the second neural network of the first codec is a transpose of the 2D-CNN.

12. The codec according to claim 10, wherein the third neural network of the second codec is a two-dimensional convolutional neural network (2D-CNN), and the fourth neural network of the first codec is a transpose of the 2D-CNN.

13. The codec according to claim 10, wherein the second codec further comprises a plurality complex ratio filters, wherein a total number of the complex ratio filters corresponds to the plurality of audio channels minus the reference channel.

14. The codec according to claim 10, wherein the reconstructing code further comprises (i) third performing code configured to cause the at least one processor to perform an inverse STFT on an output of the first codec to generate a reconstructed reference channel, (ii) third inputting code configured to cause the at least one processor to input the reconstructed reference channel and the output of the second codec into a filter, and (iii) fourth performing code configured to cause the at least one processor to perform an inverse STFT on an output of the filter to obtain the reconstructed audio signal.

15. The codec according to claim 10, wherein the first training code is based on an signal-to-noise ratio (SNR) loss function applied to the frequency domain reference channel and the output of the first codec.

16. The codec according to claim 10, wherein the second training code is based on an signal-to-noise ratio (SNR) loss applied to each non-reference channel and corresponding reconstructed non-reference channel.

17. The codec according to claim 10, wherein the first codec further comprises a first quantizer that quantizes an output of the first neural network and provides the quantized output of the first neural network to the second neural network, and wherein the second code further comprises a second quantizer that quantizes an output of the third neural network and provides the quantized output of the third neural network to the second neural network.

18. The codec according claim 10, wherein the audio signal is captured by a microphone comprising a plurality of arrays corresponding to the plurality of channels of the audio signal.

19. A non-transitory computer readable medium having instructions stored therein, which when executed by a processor in a codec for performing neural spatial audio coding, cause the processor to execute a method comprising:
receiving an audio signal comprising a plurality of channels;
selecting a channel from the plurality of channels as a reference channel;
performing a short time fourier transform (STFT) on the reference channel to generate a frequency domain reference channel;
inputting the frequency domain reference channel into a first codec that comprises a first neural network for encoding the frequency domain reference channel and a second neural network for decoding the frequency domain reference channel;
performing the STFT on the plurality of channels minus the channel selected as the reference channel to generate a spatial covariance matrix;
inputting the spatial covariance matrix and the frequency domain reference channel into a second codec that comprises a third neural network for encoding the spatial covariance matrix and the frequency domain reference channel and a fourth neural network for decoding the spatial covariance matrix;
reconstructing the audio signal based on an output of the first codec and an output of the second codec to generate a reconstructed audio signal;
training the first codec based on a comparison of the output of the first codec with the frequency domain reference channel; and
training the second codec based on a comparison of the reconstructed audio signal with the plurality of channels of the audio signal minus the reference channel.

20. The non-transitory computer readable medium according to claim 19, wherein the first neural network of the first codec is a two-dimensional convolutional neural network (2D-CNN), and the second neural network of the first codec is a transpose of the 2D-CNN.
